(19) United States
(12) Patent Application Publication
(10) Pub. No.: US 2026/0203618 A1
(43) Pub. Date: Jul. 16, 2026

(54) CONSENSUS TO HARDEN GENERATIVE AI MODELS

(71) Applicant: Dell Products L.P., Round Rock, TX (US)

(72) Inventors: Vicente J.P. Amorim, João Monlevade (BR); Roberto Nery Stelling Neto, Rio de Janeiro (BR); Werner Spolidoro Freund, Rio de Janeiro (BR)

(21) Appl. No.: 19/019,437

(22) Filed: Jan. 13, 2025

(51) Int. Cl. G06N 5/043

(52) U.S. Cl. CPC G06N 5/043

(57) ABSTRACT

One example method includes receiving an input query at an interface, forwarding the input query to a pool that includes multiple agents, receiving, by one of the agents, the input query, performing, by the one agent, operations including generating an answer to the input query, computing a checksum for the answer, broadcasting the answer and the checksum to the other agents, receiving respective answers and checksums from the other agents, calculating a respective SM value between the answer and the respective answers received from the other agents, broadcasting the SM values to the other agents, and transmitting, to the interface, an SM matrix in conjunction with a vector of all known <answer, checksum> tuples received from the other agents. Finally, the agent reaches a consensus with the other agents about validity of the SM values, and identifies the best answer, from among the answers generated by the agents.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to LLMs (large language models). More particularly, at least some embodiments relate to systems, hardware, software, computer-readable media, and methods, for using a consensus approach to harden a GenAI (generative artificial intelligence) model, while providing trustworthy answers to an input query.

### BACKGROUND

Large Language Models (LLMs) have been used as the pillars of many solutions, most of them creating conversational agents that aim to provide a more natural and effective way for humans to interact with. In practice, an LLM solution, whether using agents or not, can be interpreted as a legitimate company representative, so that an incorrect or compromised answer might be considered as the company answer on its own, and could expose the company to legal liability and/or may cause other problems. Thus, GenAI-based solutions at the enterprise level pose a distinct requirement of trustworthiness, under penalty of compromising the whole company, generating unknown and undesirable costs.

Such business conversational solutions raise at least two problems to be mitigated, to avoid harming an organization. One challenge is often referred to as “hallucination,” a condition where the LLM “creatively” predicts outputs not tied to any real or plausible fact. Another point to be considered regarding the infrastructure point-of-view is that LLMs are usually served as ordinary services and, as such, are vulnerable/susceptible to attacks just like any other service, potentially corrupting the generated content.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings. It is noted that a color version of the Figures is attached hereto as Appendix A, which is incorporated herein in its entirety by this reference.

FIG. 1 discloses aspects of a process, according to one embodiment.

FIG. 2 discloses aspects of a process (Phase 1) for individual output and self-evaluation, according to one embodiment.

FIG. 3 discloses aspects of a process for broadcasting previously generated answers by one or more agents, according to one embodiment.

FIG. 4 discloses aspects of an answer evaluation process performed by an agent, according to one embodiment.

FIG. 5 discloses aspects of a process for broadcasting respective SMs (similarity metric) calculated by one or more agents, according to one embodiment.

FIG. 6 discloses aspects of a process for wrapping up data and reaching a consensus among agents, according to one embodiment.

FIG. 7 discloses an example of a malicious Agent (1) generating an invalid answer, with its associated checksum, to an input query, according to one embodiment.

FIG. 8 discloses aspects of various phases as they may relate to the general behavior of a malicious Agent (Agent 1) attempting to make valid its incorrect/hallucinated answer, according to one embodiment.

FIG. 9 discloses aspects of various phases as they may relate to the general behavior of a malicious Agent (Agent 1) trying to under-evaluate the other answers by other agents, in an attempt to promote its own answer over the other answers, according to one embodiment.

FIG. 10 discloses an example of a malicious agent trying to corrupt an already evaluated answer, according to one embodiment.

FIG. 11 discloses aspects of an example computing entity configured and operable to perform any of the disclosed methods, processes, and operations.

### DETAILED DESCRIPTION OF SOME EXAMPLE EMBODIMENTS

Embodiments disclosed herein generally relate to LLMs (large language models). More particularly, at least some embodiments relate to systems, hardware, software, computer-readable media, and methods, for using a consensus approach to harden a GenAI (generative artificial intelligence) model, while providing trustworthy answers to an input query.

Some example embodiments comprise a method and/or architecture operable to respond to an input query. In an embodiment, a response to an input query may reflect a consensus reached amongst a group of agents. One example embodiment may be implemented in the form of, or in connection with, a virtual assistant, such as a chatbot for example, but this is presented only by way of example and is not intended to limit the scope of this disclosure, or any claims, in any way.

A method according to one example embodiment may be performed, possibly as one or more concerted actions, by a group of agents and a input interface, and may comprise various operations, including for example: receiving, from a user by a input interface, a query; forwarding the query to a pool of agents running on a backend of the input interface; receiving, by each of the agents, the input query; performing, by each of the agents, operations including: generating and revising its own answer to the input query, and computing a checksum for the answer; broadcasting the answer and checksum to the other agents; receiving respective answers and checksums from each of the other agents, and calculating an SM (similarity metric) between the received answers and the answer generated by the agent; broadcasting its SM to the other agents; transmitting, to the input interface, an SM matrix in conjunction with a vector of all known <answer, checksum> tuples received from the other agents; by the input interface, reaching a consensus about the validity of the SMs, and identifying the generated response that best suits the input query; and, transmitting the generated best response to the user.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may generate a consensus amongst a group of answers generated in response to an input query. An embodiment may provide security by performing a self-evaluation process. An embodiment may mitigate GenAI model hallucinations. Various other advantages of one or more example embodiments will be apparent from this disclosure.

### A. References

Reference is made herein to various documents, which are listed below. These documents are incorporated herein in their respective entireties by this reference.
[1] T_HQ technology and business. Air Canada refund customer like chatbot said it would (techhq.com). Last access in April/2024.
[2] BBC. Airline held liable for its chatbot giving passenger bad advice—what this meansfor travellers (bbc.com). Last access in April/2024.
[3] Brown, H., Lin, L., Kawaguchi, K. and Shieh, M., 2024. Self-Evaluation as a Defense Against Adversarial Attacks on LLMs. arXiv preprint arXiv:2407.03234.

### B. Aspects of an Example Context for One Embodiment

The following is a discussion of aspects of an example context for various embodiments. This discussion is not intended to limit the scope of the claims or this disclosure, or the applicability of the embodiments, in any way.

### B.1 LLM-Based Agents

One example embodiment leverages an LLM-based agent concept. Within this concept, an intelligent agent may comprise a reasoning architecture that includes various components:
Sensors: Defines how Agents can perceive the information about its context surroundings. It could use images, sounds, raw data, textual files, or even a web searching page as input.
Processors: Process data retrieved from sensors. Their general behavior recalls the human “brain.” As soon as the data processing is done, actuators are invoked.
Actuators: Supports the processor(s) acting on the context environment.

The agents concept goes beyond the virtual world. Agents have been used in several distinct areas, such as robotic and embedded systems, where the sensors and actuators could be illustrated as physical hardware components.

One example embodiment uses a more abstract concept of ‘agents.’ In this embodiment, the processor part is supported by an LLM, acting as the agent brain, and may thus embody an ‘LLM-based agent.’

### B.2 Self-Evaluation as a Safety Measure

It is widely known that LLMs can provide unsafe, inaccurate, and/or incomplete, answers, despite using sane curated datasets on their training. Third-party evaluation and the usage of ‘guardrails’ are some of the possible strategies to reduce the likelihood of these.

Another approach to safety measures focuses on self-evaluating the generated answers. As presented by the experiments disclosed in [3], this may be effective when an ‘LLM B’ evaluates the answers generated by an ‘LLM A.’ One example embodiment goes further and comprises an LLM-free cross-evaluation layer, as discussed in further detail below. A method according to one embodiment removes the model from the quality evaluation loop, thus avoiding reinserting the uncertainty created by this type of model. In an embodiment, this cross-evaluation layer works by calculating a similarity metric on the outputs of self-evaluation step, adding further robustness.

### C. Overview of Aspects of One Embodiment

An embodiment may operate to leverage a consensus approach to harden models, such as LLMs, being served by a backend infrastructure that deals with the broader public. Thus, an embodiment may consider, and comprise an approach for, the following:
How to harden LLM models from a malicious intervention;
Increase the trustworthiness of outputs generated by LLMs-based applications; and
Reduce the likelihood of generating a compromised answer when hallucinating.
   Thus, one or more embodiments may reduce the impact of an attacker while simultaneously increasing the robustness of model outputs against hallucinations.

In more detail, an embodiment considers a generic architecture for chatbots, with an end-input interface supported by a backend, which serves the necessary infrastructure and manages the LLMs. One or more embodiments may be applied to a wide range of scenarios, from plain vanilla content generation to even more complex ones like Retrieval Augmented Generation (RAG). One embodiment may comprise a modification of a conventional backend structure to embed a consensus mechanism aiming to harden the outputs generated by LLMs, so as to minimize the consequences of malicious attacks and internal faults such as hallucinations.

One example embodiment may involve a variety of actors, including:
User: The main entity that interacts with an interface, providing prompts and expecting obtaining results from that. The user here may, or may not, have malicious intentions. One embodiment may consider that user access is limited to the interface. In this way, the harm, if any, this kind of user can do may be limited to prompt injection, data exfiltration techniques, and similar attacks.
Input interface: Any existing interface that enables user to interact with the models on the backend. In one or more example embodiments, this interface might comprise any API (application program interface), graphical UI (input interface), or similar structure.
Potential malicious attacker: A malicious entity that, deliberately or accidentally, aims to subvert the conventional behavior of the LLM-based applications. The scope of this disclosure is not limited to any particular potential actions a malicious attacker can do to compromise an LLM-based solution. Thus, an embodiment improves the robustness of an agent by hardening the LLM-based agent final output.
LLM-based agents: Instead of having only a single answer-generation LLM-based agent, an embodiment may comprise, and use, several intelligent answer-generation LLM-based agents in a cluster-like fashion. In this regard, the risk of a single failure point with one LLM agent answering queries can be mitigated, in one embodiment, by using many LLMs in parallel, along with use of an additional integrity check. In some cases, if LLM cost is an issue, a single costly LLM can be replaced by a collection of lighter LLMs. This tradeoff may comprise an implementation decision and may vary according to the deployment context. For the sake of simplicity, the terms “agents” and “LLM-based agents” are used herein interchangeably and refers to an agent that is based on an LLM.

A method according to one example embodiment may comprise the following operations:
1. The user sends a query to the interaction “Interface” looking for the answer provided by the application running on the backend.
2. The interface forwards the input query to a pool of agents—or a subset of agents in the pool—running on the backend.
   The agents receive the input query, and run through a phased procedure that aims to generate a consensual valid answer at the end. Although some agents could be compromised, an embodiment may comprise a consensus mechanism to decide about the trustworthiness of the final answer to be sent to the user in response to the input query. An embodiment may use (2F+1) agents, where F is the maximum number of malicious agents the system supports. The phases implemented in/by an embodiment may comprise:
      1. Phase 1: Task completion: Every agent will generate and revise its own answer to the input query. In the end, the Agent computes the checksum/digest related to that answer.
      2. Phase 2: Answers and their corresponding checksums are broadcast between all agents of the pool.
      3. Phase 3: Every agent calculates a Similarity Metric (SM) between all the received answers against its own answer.
      4. Phase 4: Calculated SMs are then broadcasted to the other agents on the pool.
      5. Phase 5: Every agent sends back to the user “Interface” its own SM matrix in conjunction with a vector of all known <answer, checksum> tuples from the other agents.
         After the conclusion of Phase 5, the user ‘Interface’ can reach a consensus about SM validity, as well as a consensus as to the generated response that best responds to the input query.

As discussed above, and also disclosed elsewhere herein, embodiments may comprise various useful features and aspects, although no embodiment is required to possess any of such features or aspects. The following examples are illustrative, but not exhaustive.

An embodiment may comprise a mechanism that ensures consensus in an LLM-based agents backend. By leveraging this consensus mechanism, an embodiment may harden the correctness of the answer provided by backend, even under a malicious faulty condition. The consensus mechanism also provides the ability to unveil potential malicious Agents by comparing all the outputs from every element within a group of Agents.

An embodiment may comprise a cross-evaluation method that includes a safety layer. For example, an embodiment may comprise an extension of the self-evaluation method in [3] by including a cross-evaluation layer. This approach, according to one embodiment, removes the LLM from the evaluation loop and uses similarity specific metrics to rank answer quality.

An embodiment may operate to mitigate GenAI model hallucinations by double checking the output provided by LLM-based agents. By including Agents on the backend, an embodiment comprises a self-reviewing environment, increasing the robustness of the approach. In addition to checking its own answers, an Agent also double checks its peer data, that is, data from one or more other Agents, and thus may potentially diminish the overall chance of hallucinations.

### D. Detailed Discussion of Aspects of an Embodiment

### D.1 Introduction

One embodiment comprises a method to reduce the undesirable impact caused by erroneous/incorrect answers from LLM-based applications, whether such answers and applications are malicious or not. An embodiment may provide robustness to the answer, or content, generation process by leveraging redundancy on backend components. Following is a discussion of various aspects of an embodiment that uses multiple LLM Agents.

Depending upon the circumstances, generating content using LLMs can be a straightforward task, which may be as simple as calling an API with selected parameters. However, given the current state of LLM technology, providing robust and correct outputs can become a challenging task.

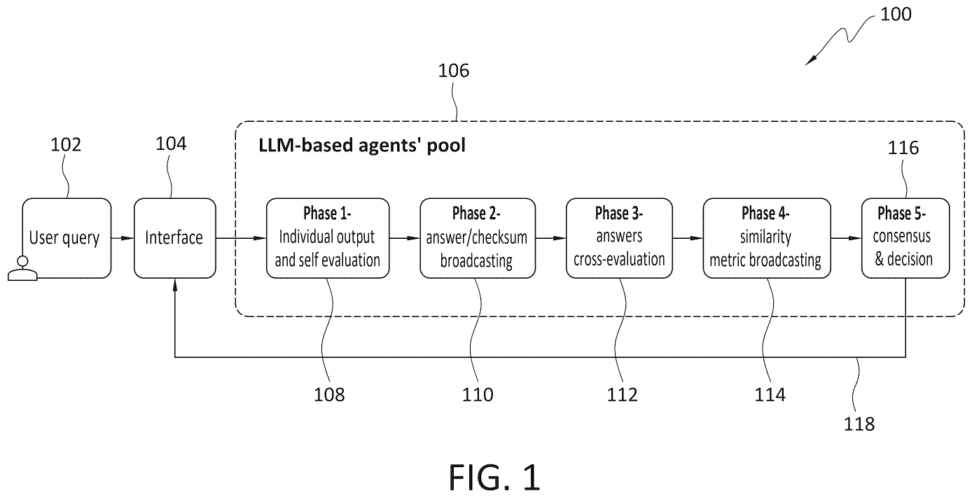

FIG. 1 discloses an example schema 100 according to one embodiment. By way of introductory overview, and as shown in FIG. 1, a user may submit an input query 102, such as a request for information, or a question. The input query 102 may be submitted by the user through a input interface (UI) 104 which may comprise, for example, a graphical input interface (GUI), command line interface (CLI), and/or other type(s) of interface(s). In an embodiment, the input interface 104 may operate to translate the input query 102 into a form that is understandable by internal entities such as the LLM-based agents of the pool 106.

The input interface 104 may then pass the input query 102, thus translated, to a pool 106 that comprises multiple LLM-based agents. In an embodiment, each of the LLM-based agents may perform a method that comprises various phases such as, but not limited to, Phase 1 (108), Phase 2 (110), Phase 3 (112), Phase 4 (114), and Phase 5 (116). Performance of the method that comprises these Phases may result in the identification and generation of a consensual and robust answer that may then be returned 118 by the pool 106 to the user that initiated the input query 102.

The discussion below considers aspects of an embodiment considering an embodiment based on LLM-based agents. The “Normal Operation Flow” discussion describes how everything executes without having any malicious agent on the system. Conversely, the “Exception Operation Flow” discussion explores scenarios where errors are deliberately/accidentally inserted into the environment.

### D.2 Discussion

### D.2.1 Normal Operation Flow

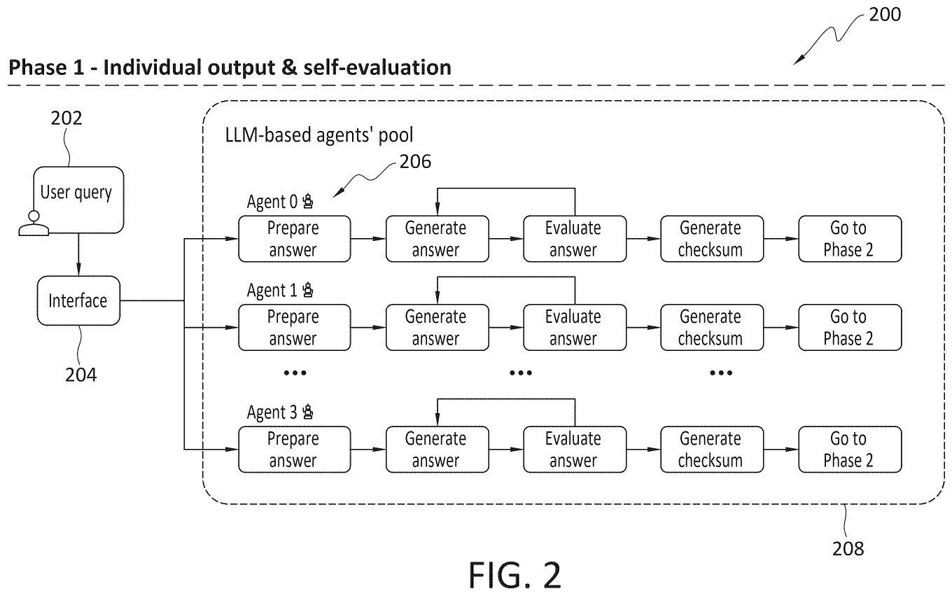

With continued attention to FIG. 1, and directing attention now to the example of FIG. 2 as well, the ‘normal operation’ flow describes how an embodiment may behave when there are no malicious actors in the environment. Even in this situation, an embodiment may produce improvements with respect to current approaches, at least insofar as an embodiment may enhance the quality of the final answer provided to the user by providing the answer with the best rating as converged by a consensus of properly operating agents. This reduces the probability of providing answers that include hallucinations. In an embodiment, all communication between parties, that is, the LLM-based agents, may be signed and encrypted.

### D.2.1.1 Phase 1—Individual Output & Self-Evaluation

As noted above, and with particular reference now to the example schema 200 for Phase 1 disclosed in FIG. 2, after the user sends its query 202 through the input interface 204, a method according to one embodiment performs 5 different phases, at the completion of which, a valid answer may be obtained. FIG. 2 discloses an example of Phase 1, namely, ‘Individual output & self-evaluation.’

As shown in FIG. 2, the user sends an input query 202 to the input interface 204, which will send the input query 202 to an arbitrary number of Agents 206 executing on the backend as members of an LLM-based agents pool 208. In an embodiment, the number of agents (NA) is given by the equation NA=2F+1, where F is the maximum number of malicious agents the system supports.

As shown, each agent 206 loops between the “Generate answer” and “Evaluate Answer” blocks until:
A) The agent 206 judges the generated answer has enough quality to continue. To do that, an embodiment may define a threshold (T_{q}) that provides a quantitative measure for the output text. As a possible embodiment, T_{q} could use commonly known function qualities, such as entailment, cosine similarity, or any combination of them. Some of these functions can affect the

$$\frac{tokens}{s}$$

throughput, what must be taken into consideration when defining T_{q}
B) The agent 206 may loop for a maximum specified number of iterations k. The k value may be set according to its application context, hardware constraints, answer response time, LLMs hyperparameters, among others.
   Having a satisfactory answer may increase the chance that an answer of a particular agent will be selected as the “best” one by the input interface 204 in the end. After an answer has been selected by an agent, a checksum for the answer may be calculated as shown at “Generate Checksum,” enabling further process/entities verify whether the answer has been corrupted/changed or not.

### D.2.1.2 Phase 2—Answer/Checksum Broadcasting

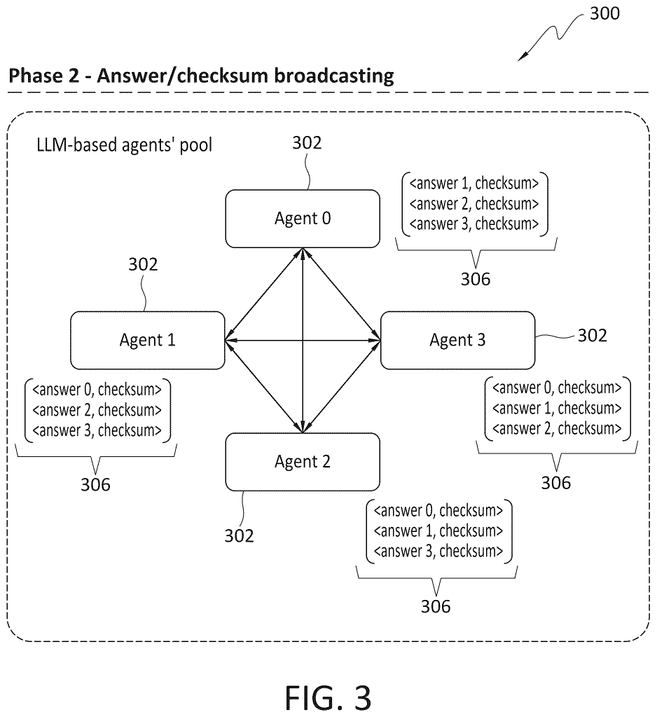

With continued attention to FIG. 1, and directing attention now to FIG. 3 as well, details are provided concerning an example of a Phase 2 such as may comprise an element of a method according to one embodiment. FIG. 3 discloses an example schema 300 for a Phase 2, ‘answer/checksum broadcasting.’ In an embodiment, Phase 2 may comprise broadcasting the previously generated answers by the agent.

In more detail, during Phase 2, all agents 302 broadcast their tuples of <answer, checksum> to the other agents 302 that are members of the LLM-based agent pool 304. This broadcast increases the general robustness of one embodiment, as now every member, that is, every agent 304, knows details about what was generated by its counterpart. In the end of this example Phase 2, the same snapshot, or matrix 306, of tuples <answer, checksum> will be replicated on every agent 304. It is noted that, in an embodiment, there may be a timeout limit for receiving data from other agents 304 but, as the focus of one embodiment is consensus, not resilience, this can be implemented in any suitable scheme, where the consequence is that the node, or agent 304, that failed to send information will either be “without information” on the corresponding lines/columns of other agent 304 matrices, or will have different information on other agent 304 matrices.

### D.2.1.3 Phase 3—Answers Cross-Evaluation

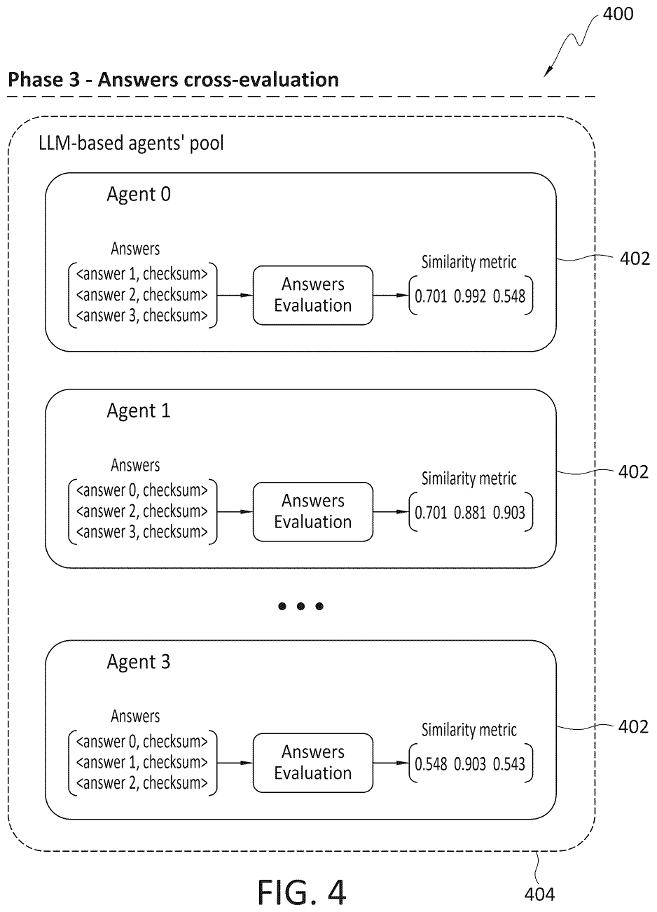

With continued attention to FIG. 1, and directing attention now to FIG. 4 as well, details are provided concerning an example of a Phase 3 such as may comprise an element of a method according to one embodiment. FIG. 4 discloses an example schema 400 for a Phase 3, ‘answers cross-evaluation.’ In an embodiment, Phase 3 may comprise performing an answer cross-evaluation process, in which each agent 402 of an LLM-based agent pool 404 performs an evaluation process of answers generated by the other agents 402.

In more detail, during an embodiment of a Phase 3, every agent 402 calculates an SM between its own answer and every answer received from the other agents 402, generating N−1 values that fill out a resulting vector expressed as:

$${MV}_{Ax} [ {A}_{y} ] = SM ( {A}_{x} , {A}_{y} ) ,$$

where:

MV_{AX}[A_{y}]: The value stored into Metrics Vector of Agent X at the position Y. SM(Aₓ, A_{y}): The SM calculated between the respective answers from Agent X and Agent Y.

An embodiment uses the ‘metric’ term, at the expense of any raw similarity measure, because the metrics can provide more context, relative to a raw similarity measure, to the calculated values of SM. Given the equation above, the values for MV_{Ax}[A_{y}] and MV_{Ay}[Aₓ] must be equivalent, so that there is a standard or normalized way to rank the SMs of all answers. At the end of Phase 3, every agent 402 will hold a local vector containing N−1 values, corresponding to answers coming from the other (N−1) agents 402.

### D.2.1.4 Phase 4—Similarity Metric (SM) Broadcasting

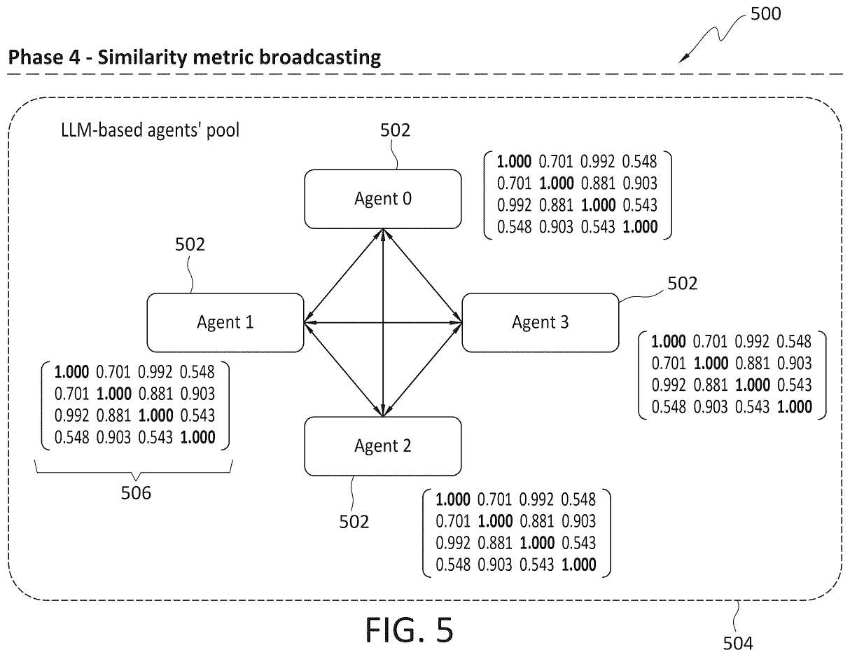

With continued attention to FIG. 1, and directing attention now to FIG. 5 as well, details are provided concerning an example of a Phase 4 such as may comprise an element of a method according to one embodiment. FIG. 5 discloses an example schema 500 for a Phase 4, ‘similarity metric broadcasting.’ In an embodiment, Phase 4 may comprise performing a process of broadcasting SMs calculated by the preceding Phase 3.

In Phase 4, agents 502 of an LLM-based agent pool 504 broadcast their own SM vector, one example of which is denoted at 506, that was previously calculated. This process occurs until all agents 502 receive information about every other agent 502. At the end, instead of a single vector, every agent has a matrix that comprises all the vectors from the other agents 502, and which describes the SMs from all agents to all agents.

It is noted that in this example, and mentioned earlier herein, Phase 4 is in a “Normal flow” of execution, in which there is no malicious or erroneous behavior. Thus, the respective matrices 506 of all agents 502 should reflect the same values, creating a single, and global within the LLM-based agent pool 504, knowledge representation about all the answers that have been generated. As well, reference is made to the previously mentioned equivalence of calculated SMs. That is, a given position MV[x, y] will get the same value as MV[y, x]. Likewise, the matrix main diagonal is filled out with maximum similarity value of 1.0, as this constitutes the agent 502 evaluation of its own answer.

### D.2.1.5 Phase 5—Consensus & Decision

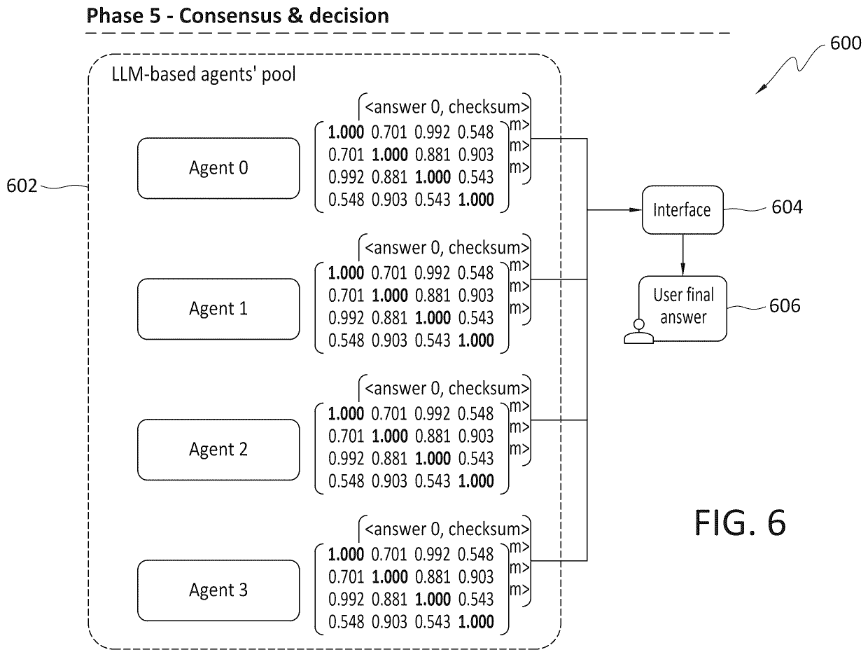

With continued attention to FIG. 1, and directing attention now to FIG. 6 as well, details are provided concerning an example of a Phase 5 such as may comprise an element of a method according to one embodiment. FIG. 6 discloses an example schema 600 for a Phase 5, ‘consensus & decision.’ In an embodiment, Phase 5 may comprise performing a process of consensus and decision with regard to an answer to be provided to a user in response to an input query.

The hardening characteristic of one embodiment lays out having a distributed approach to simultaneously calculate and store the SMs of all answers. This last phase, that is, Phase 5, wraps up previous phases by forwarding, from the LLM-based data agent pool 602, data such as checksums and associated answers to the input interface 604. In an embodiment, the input interface 604 oversees the collecting of results and deciding about the best answer that fits the input query. Once it is done, the input interface 604 sends the best answer 606 back to the user.

With continued reference to the examples of FIG. 1 and FIG. 6, an embodiment may comprise various tasks performed by a input interface, such as the input interface 604 for example:
1. By analyzing all the received matrices, a input interface may decide whether a consensus was reached or not. An embodiment may define a customized consensus rule (hard/soft) by changing the minimum number of matrices that must be equivalent. In the “Normal flow” circumstance, all matrices must be equal.
2. By looking into the SMs, matrices, and the vectors of <answer, checksum> tuples, a input interface may decide which is the best answer to return to the user. This task may be particularly important, as choosing the right answer reduces the likelihood of providing a hallucinated one.

One or more embodiments may be agnostic as to the particular way in which the input interface roles are performed. Thus, each embodiment may define the best way to perform these roles by analyzing the provided structures (matrices and vectors), as they are sufficient to ensure consensus and data sanity.

### D.2.2 Exception Operation Flows

As noted earlier herein, an embodiment may at times operate in a normal operation flow, although that is not necessarily always the case. Following is a discussion of how an embodiment may address various different exception scenarios, while still ensuring the sanity of results at the end. Consider that, in every flow, there may be at least one malicious agent running on the backend. In one instance, such an agent works by biasing the system into providing incorrect answers.

### D.2.2.1 Exception Flow 1

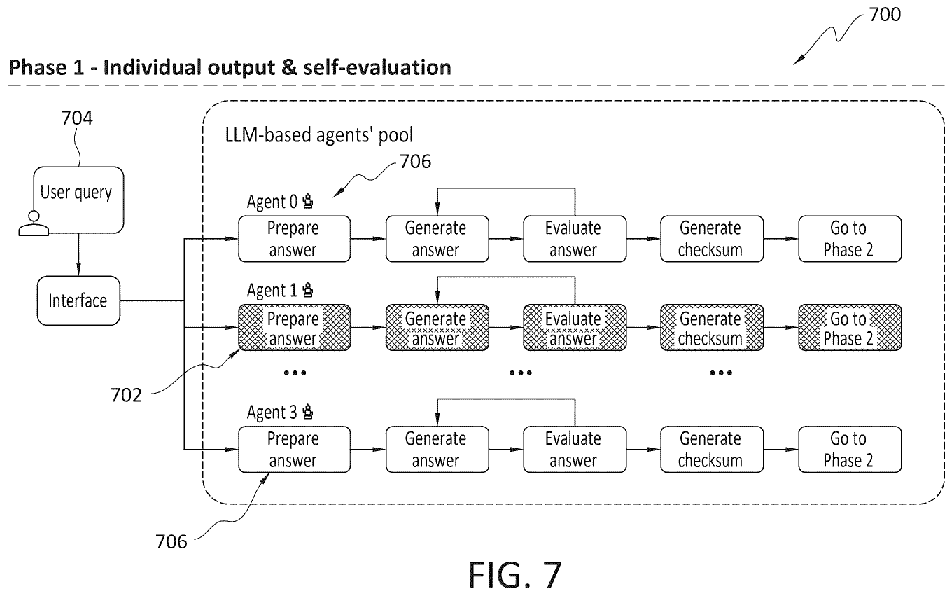

With attention now to the schema 700 of FIG. 7, consider the example of Exception Flow 1 in which of a malicious agent (1) 702 generating an invalid answer, with its associated checksum, to an input query 704. For the malicious agent (1) 702, the most straightforward way of attack may be attempting to generate an incorrect answer for the input query 704. In this case, the malicious agent (1) 702 will use its internal LLM to create an invalid/biased/hallucinated text, trying to induce other legitimate agents 706, such as agent (0) and agent (3), to adopt its answer as a legitimate one.

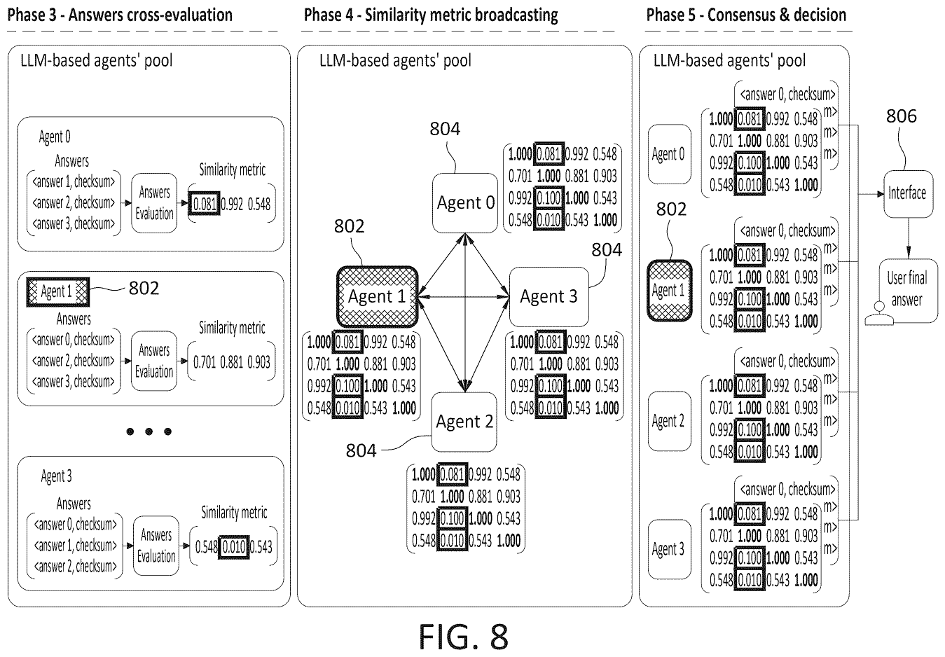

Despite the possibility of contaminating the remaining agents 706, the execution of every phase (see FIG. 1) proceeds until Phase 3 is reached. From that point onwards, and with reference now to the example of FIG. 8 disclosing a malicious agent 802, and other uncompromised agents 804, the remaining agents 804 may note the lack of a relevant SM between their own answers and the answers generated by the malicious agent 802. That is, FIG. 8 shows examples of Phase 3, 4, and 5, indicating the general behavior of the malicious agent 802 attempting to make valid its incorrect/hallucinated answer. During “consensus & decision” (Phase 5), the input interface 806 evaluates the received data, deciding whether that data is valid or not by checking items including:
a. Received SM matrices must converge to a single distributed data structure. This means the dimensions and internal values must be the same for most agents. Therefore, a malicious agent 802 could present significant changes on those variables.
b. The malicious agent 702/802 can reproduce the valid SM matrix by replicating other Agent evaluation about its answer, that is, by pretending all matrices are equals. In this case, the input interface 806 can use SM values to disintermediate valid from invalid answers—as the invalid ones can be expected to have low SM.

### D.2.2.2 Exception Flow 2

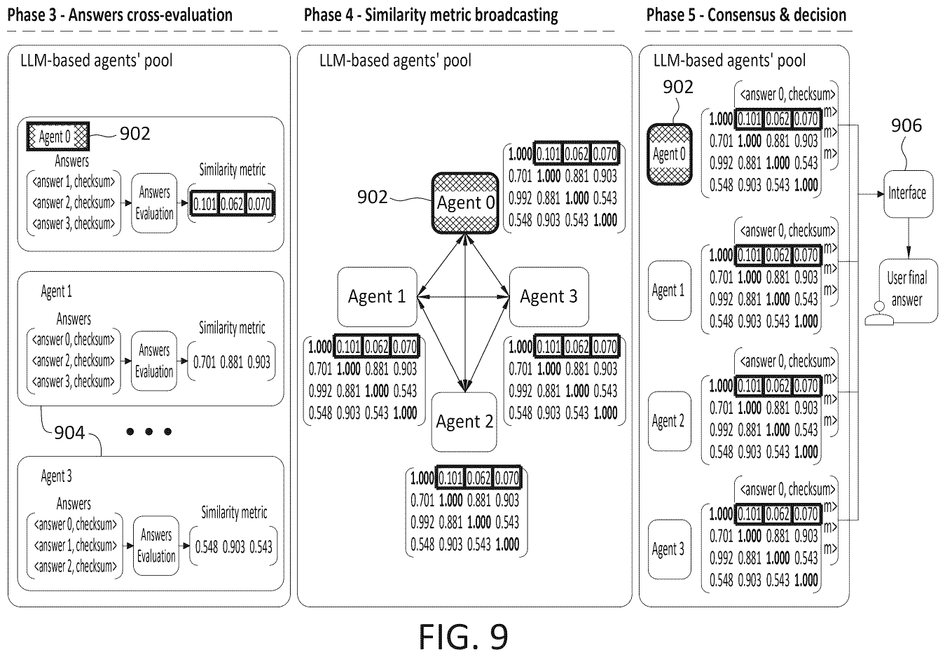

With attention now to the example of FIG. 9, there is disclosed an example of Phases 3, 4, and 5, indicating the general behavior of a malicious agent 902 attempting to under-evaluate the answers from the other agents 904 so as to advance or promote its own answer relative to the other answers.

In the example of Exception Flow 2, another attack involves the possibility of the malicious agent 902 deliberately under-evaluating the respective answers of the other agents 904 answers. In this case, an embodiment may execute as in the “Normal Flow” until it reaches Phase 3. Then, as disclosed in FIG. 9, the malicious agent 902 deliberately generates lower values for any other answer other than its own answer.

In this circumstance, the input interface 906 potentially identifies the malicious agent 902 behavior by comparing the SMs on the final matrices. The SMs calculated by the malicious agent 902 do not match with its counterparts (MV_{Ax}[A_{y}]≠MV_{Ay}[Aₓ]), thus indicating to the input interface 906 that the input interface 906 should discard such values from the malicious agent 902.

### D.2.2.3 Exception Flow 3

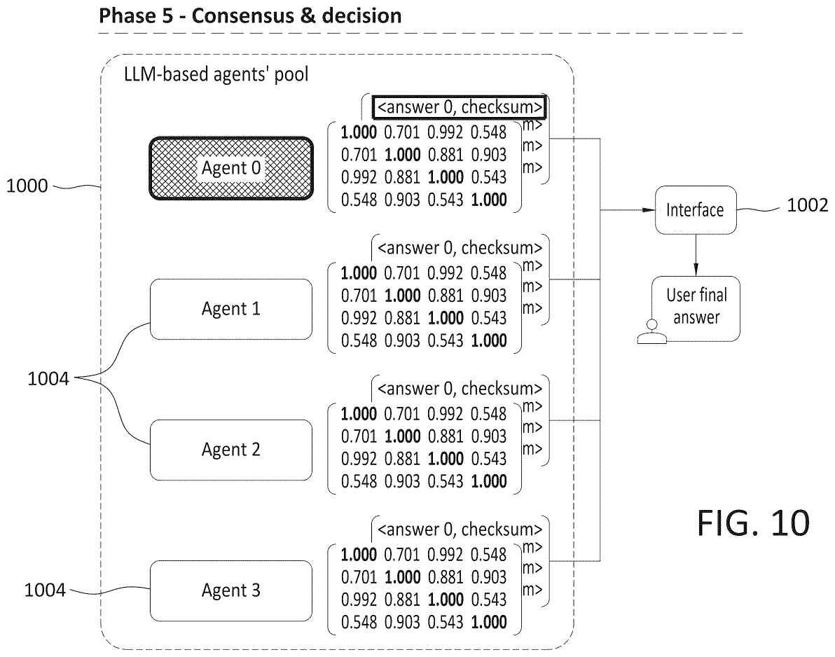

With attention now to FIG. 10, there is disclosed an example in which a malicious agent 1000 is attempting to corrupt an already evaluated answer. That is, the answer may be corrupted after the fact when the evaluation has already been performed.

In particular, FIG. 10 discloses a circumstance in which a malicious agent 1000 can act legitimately until Phase 5, generating a valid high-quality answer. At this last step however, the malicious agent 1000 modifies its own answer by a corrupted one, instigating the input interface 1002 to select that answer based on the agent group evaluation SM—which considers the previous/legitimate answer.

One embodiment may deal with this circumstance by making the input interface 1002 verify the sanity or reasonableness of all answers for malicious agent 1000 and legitimate agents 1004. In an embodiment, this may be done by using the input interface 1002 to compare the answer of the malicious agent <answer, checksum> against its own <answer, checksum> held by the other agents 1004, along with matching the checksums. On Phase 5, all the agents 1000 and 1004 must send the same SM matrices and <answer, checksum> tuples to the interface 1002, so that any corruption may be easily detected. This adds another layer of robustness to an embodiment, enabling such an embodiment to promptly detect, and possibly discard, a deviate behavior, which may take the form of a compromised answer.

### D.2.3 Ensuring Consensus

An embodiment comprises a distributed consensus approach. By defining a maximum number of compromised actors (or failures), it is possible to draw the hyper-parameters that support consensus implementation—as an embodiment may ensure the permanent existence of a minimum number of legit actors. Additionally, “Normal Flow” and “Exception Flows” illustrate the importance of ensuring consensus. From the examples outlined here, it can be seen that any anomalous behavior, whether deliberate or accidental, is promptly identified by a input interface, as that input interface has access to the matrices of SM and <answer, checksum> tuples respectively associated with the various agents.

### D.2.4 Reducing Hallucination Likelihood

As noted herein, the existence of N independent agents running in parallel to answer a given question increases the overall robustness of an embodiment. At the end of a ‘normal’ or ‘exception’ flow, the input interface selects the best result between N answers. Particularly, the input interface uses grades generated by all agents during a cross-evaluation process (Phase 3). By doing that, an embodiment may reduce the likelihood that an LLM will create a hallucinated answer, once the best answer has been cross-checked by every running agent.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method, comprising: receiving an input query from an input entity; forwarding, by the input entity, the input query to a pool that comprises agents running on a backend of the input interface; receiving, by one of the agents in the pool, the input query;
performing, by the one agent, operations comprising: generating an answer to the input query; computing a checksum for the answer; broadcasting the answer and the checksum to the other agents; receiving respective answers and checksums from the other agents; calculating a respective SM (similarity metric) value between the answer and the respective answers received from the other agents; broadcasting the SM values to the other agents; and transmitting, to the input entity, an SM matrix in conjunction with a vector of all known <answer, checksum> tuples received from the other agents; and by each agent, reaching a consensus with the other agents about validity of the SM values, and then broadcasting the answer to the input entity, from among the answers generated by the agents, that best suits the input query.

Embodiment 2. The method as recited in any preceding embodiment, wherein the input interface translates the input query into a form understandable by the agents.

Embodiment 3. The method as recited in any preceding embodiment, wherein the input interface transmits the best answer as an output.

Embodiment 4. The method as recited in any preceding embodiment, wherein the one agent performs a check on the answers and checksums received from the other agents to determine whether or not one or more of the other agents has hallucinated.

Embodiment 5. The method as recited in any preceding embodiment, wherein each of the agents is an LLM (large language model)—based agent.

Embodiment 6. The method as recited in any preceding embodiment, wherein each of the checksums is generated after the respective agent has evaluated the answer generated by that respective agent.

Embodiment 7. The method as recited in any preceding embodiment, wherein the input interface is operable to detect, using one or more of the SM values, when one of the answers generated by one of the agents is incorrect due to a hallucination, or due to a malicious act.

Embodiment 8. The method as recited in any preceding embodiment, wherein the input interface is operable to detect, by determining that one of the SM values in the SM matrix generated by one of the agents does not match the SM values in the SM matrices respectively generated by the other agents.

Embodiment 9. The method as recited in any preceding embodiment, wherein the input interface is operable to identify an agent as a malicious agent by comparing the <answer, checksum> tuple of that agent with the respective <answer, checksum> tuples of the other agents.

Embodiment 10. The method as recited in any preceding embodiment, wherein a system that includes the agents and the input interface supports (2F+1) agents, where ‘F’ is a maximum number of compromised agents that the system can support.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

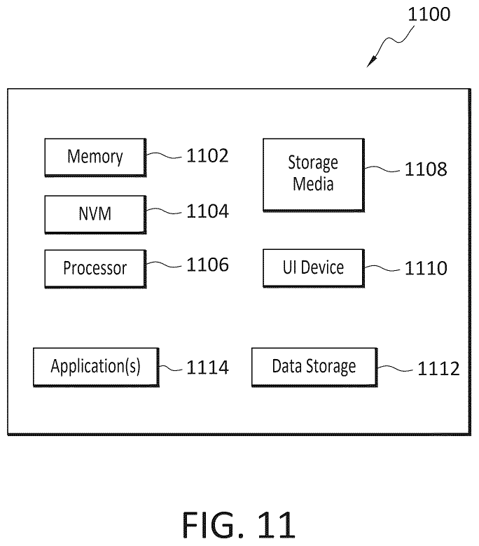

With reference briefly now to FIG. 11, any one or more of the entities disclosed, or implied, by FIGS. 1-10, and/or elsewhere herein, may take the form of, or include, or be implemented on, or hosted by, a physical computing device, one example of which is denoted at 1100. As well, where any of the aforementioned elements comprise or consist of a virtual machine (VM), that VM may constitute a virtualization of any combination of the physical components disclosed in FIG. 11.

In the example of FIG. 11, the physical computing device 1100 includes a memory 1102 which may include one, some, or all, of random access memory (RAM), non-volatile memory (NVM) 1104 such as NVRAM for example, read-only memory (ROM), and persistent memory, one or more hardware processors 1106, non-transitory storage media 1108, UI device 1110, and data storage 1112. One or more of the memory components 1102 of the physical computing device 1100 may take the form of solid state device (SSD) storage. As well, one or more applications 1114 may be provided that comprise instructions executable by one or more hardware processors 1106 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving an input query from an input entity;
forwarding, by the input entity, the input query to a pool that comprises agents running on a backend of the input interface;
receiving, by one of the agents in the pool, the input query;
performing, by the one agent, operations comprising:
generating an answer to the input query;
computing a checksum for the answer;
broadcasting the answer and the checksum to the other agents;
receiving respective answers and checksums from the other agents;
calculating a respective SM (similarity metric) value between the answer and the respective answers received from the other agents;
broadcasting the SM values to the other agents; and
transmitting, to the input entity, an SM matrix in conjunction with a vector of all known <answer, checksum> tuples received from the other agents; and
by each agent, reaching a consensus with the other agents about validity of the SM values, and then broadcasting the answer to the input entity, from among the answers generated by the agents, that best suits the input query.

2. The method as recited in claim 1, wherein the input interface translates the input query into a form understandable by the agents.

3. The method as recited in claim 1, wherein the input interface transmits the best answer as an output.

4. The method as recited in claim 1, wherein the one agent performs a check on the answers and checksums received from the other agents to determine whether or not one or more of the other agents has hallucinated.

5. The method as recited in claim 1, wherein each of the agents is an LLM (large language model)—based agent.

6. The method as recited in claim 1, wherein each of the checksums is generated after the respective agent has evaluated the answer generated by that respective agent.

7. The method as recited in claim 1, wherein the input interface is operable to detect, using one or more of the SM values, when one of the answers generated by one of the agents is incorrect due to a hallucination, or due to a malicious act.

8. The method as recited in claim 1, wherein the input interface is operable to detect, by determining that one of the SM values in the SM matrix generated by one of the agents does not match the SM values in the SM matrices respectively generated by the other agents.

9. The method as recited in claim 1, wherein the input interface is operable to identify an agent as a malicious agent by comparing the <answer, checksum> tuple of that agent with the respective <answer, checksum> tuples of the other agents.

10. The method as recited in claim 1, wherein a system that includes the agents and the input interface supports (2F+1) agents, where ‘F’ is a maximum number of compromised agents that the system can support.

11. A non-transitory storage medium having stored therein instructions that are executable by one or more hardware processors to perform operations comprising:
receiving an input query from an input entity;
forwarding, by the input entity, the input query to a pool that comprises agents running on a backend of the input interface;
receiving, by one of the agents in the pool, the input query;
performing, by the one agent, operations comprising:
generating an answer to the input query;
computing a checksum for the answer;
broadcasting the answer and the checksum to the other agents;
receiving respective answers and checksums from the other agents;
calculating a respective SM (similarity metric) value between the answer and the respective answers received from the other agents;
broadcasting the SM values to the other agents; and
transmitting, to the input entity, an SM matrix in conjunction with a vector of all known <answer, checksum> tuples received from the other agents; and
by each agent, reaching a consensus with the other agents about validity of the SM values, and then broadcasting the answer to the input entity, from among the answers generated by the agents, that best suits the input query.

12. The non-transitory storage medium as recited in claim 11, wherein the input interface translates the input query into a form understandable by the agents.

13. The non-transitory storage medium as recited in claim 11, wherein the input interface transmits the best answer as an output.

14. The non-transitory storage medium as recited in claim 11, wherein the one agent performs a check on the answers and checksums received from the other agents to determine whether or not one or more of the other agents has hallucinated.

15. The non-transitory storage medium as recited in claim 11, wherein each of the agents is an LLM (large language model)—based agent.

16. The non-transitory storage medium as recited in claim 11, wherein each of the checksums is generated after the respective agent has evaluated the answer generated by that respective agent.

17. The non-transitory storage medium as recited in claim 11, wherein the input interface is operable to detect, using one or more of the SM values, when one of the answers generated by one of the agents is incorrect due to a hallucination, or due to a malicious act.

18. The non-transitory storage medium as recited in claim 11, wherein the input interface is operable to detect, by determining that one of the SM values in the SM matrix generated by one of the agents does not match the SM values in the SM matrices respectively generated by the other agents.

19. The non-transitory storage medium as recited in claim 11, wherein the input interface is operable to identify an agent as a malicious agent by comparing the <answer, checksum> tuple of that agent with the respective <answer, checksum> tuples of the other agents.

20. The non-transitory storage medium as recited in claim 11, wherein a system that includes the agents and the input interface supports (2F+1) agents, where ‘F’ is a maximum number of compromised agents that the system can support.
